(19) United States
(12) Patent Application Publication
(10) Pub. No.: US 2010/0282408 A1
(43) Pub. Date: Nov. 11, 2010

(54) METHOD AND DEVICE FOR LINING A PIPE

(76) Inventor: Kirk E. Kuipers, Douglas, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/437,270

(22) Filed: May 7, 2009

(51) Int. Cl. B29C 63/26

(52) U.S. Cl. 156/287; 156/423

(57) ABSTRACT

A method for lining an interior portion of a pipe includes inserting a vacuum bag having a first end and a second end inside the pipe. A porous media is inserted between the vacuum bag and the pipe. The first end of the vacuum bag is removably sealed to a first end of the pipe. The second end of the vacuum bag is removably sealed to a second end of the pipe. An airtight cavity is formed between the vacuum bag and the pipe. A draw hose is removably connected from the airtight cavity to a resin container. A vacuum hose is removably connected from the airtight cavity to a vacuum source. The vacuum source is activated thereby drawing resin from the resin container into the draw hose and the airtight cavity. The liquid resin is set until the liquid resin has formed a hardened layer.

### BACKGROUND OF THE INVENTION

The present invention generally relates to a method for lining a pipe, and more specifically, to a vacuum device for lining an interior portion of a pipe.

### SUMMARY OF THE INVENTION

In one aspect of the present invention, a method for lining an interior portion of a pipe includes inserting a vacuum bag having a first end and a second end inside the pipe. A porous media is inserted between the vacuum bag and the pipe. The first end of the vacuum bag is removably sealed to a first end of the pipe. The second end of the vacuum bag is removably sealed to a second end of the pipe. An airtight cavity is formed between the vacuum bag and the pipe. A draw hose is removably connected from the airtight cavity to a resin container. A vacuum hose is removably connected from the airtight cavity to a vacuum source. The vacuum source is activated thereby drawing resin from the resin container into the draw hose and the airtight cavity. The liquid resin is set until the liquid resin has formed a hardened layer.

In another aspect of the present invention, a method for lining the interior of a container includes inserting a porous media against an interior wall of the container. A flexible vacuum bag having an open mouth is inserted against the porous media. The open mouth of the vacuum bag is removably sealed to the large container adjacent an opening in the container. An airtight cavity is formed between the vacuum bag and the container. A first end of a draw hose is removably connected to the vacuum bag such that the draw hose is in communication with the airtight cavity. A second end of the draw hose is connected to a resin container. A first end of a vacuum hose is removably connected to the vacuum bag such that the vacuum hose is in communication with the airtight cavity. A second end of the vacuum hose is connected to a vacuum source. The vacuum source is activated thereby drawing air from the airtight cavity and creating a low pressure condition. Resin is drawn from the resin container into the draw hose and the airtight cavity. The liquid resin is set until the liquid resin has formed a hardened layer.

In yet another aspect of the present invention, a lining device is provided for lining an interior area of a hollow object. A vacuum bag includes first and second open ends removably sealed proximate first and second ends of the hollow object to form a substantially tubular airtight cavity between the hollow object and the vacuum bag. A porous media is positioned between the hollow object and the vacuum bag. A draw hose is in communication with the substantially airtight cavity. A liquid resin is in communication with the draw hose. A vacuum hose is connected with the vacuum bag and in communication with the substantially airtight cavity. A vacuum source is in communication with the vacuum hose, wherein activation of the vacuum source results in a negative pressure in the vacuum hose, airtight cavity, and draw hose, thereby drawing resin from the reservoir into the airtight cavity.

These and other features, advantages and objects of the present invention will be further understood and appreciated by those skilled in the art upon studying the following specification, claims, and appended drawings.

### BRIEF DESCRIPTION OF THE DRAWINGS

FIG. 1 is a top perspective view of one embodiment of a lining device of the present invention;

FIG. 2 is an exploded top perspective view of one end of a pipe prior to lining;

FIG. 3A is a partial top perspective view of one embodiment of a pipe ready for lining;

FIG. 3B is a side cross-sectional elevational view of the pipe of FIG. 3A;

FIG. 4A is a partial top perspective view of another embodiment of a pipe ready for lining;

FIG. 4B is a side cross-sectional elevational view of the pipe of FIG. 4A;

FIG. 5A is a partial top perspective view of another embodiment of a pipe ready for lining;

FIG. 5B is a side cross-sectional elevational view of the pipe of FIG. 5A;

FIG. 5C is a side cross-sectional elevational view of the pipe of FIG. 5A during the lining process;

FIG. 5D is an enlarged side cross-sectional view of area VD of FIG. 5C;

FIG. 5E is an enlarged side cross-sectional view after resin has impregnated the porous media and chamfer;

FIG. 5F is a side cross-sectional elevational view of the pipe of FIG. 5A after being lined;

FIG. 6A is a partial top perspective view of another embodiment of a pipe ready for lining;

FIG. 6B is a side cross-sectional elevational view of the pipe of FIG. 6A;

FIG. 7A is a partial top perspective view of another embodiment of a pipe ready for lining;

FIG. 7B is a side cross-sectional elevational view of the pipe of FIG. 7A;

FIG. 8 is a side cross-sectional elevational view of another embodiment of a lining device of the present invention during the process of lining a large tank; and

FIG. 9 is a side cross-sectional elevational view of the tank of FIG. 8 after lining.

### DETAILED DESCRIPTION OF PREFERRED EMBODIMENT

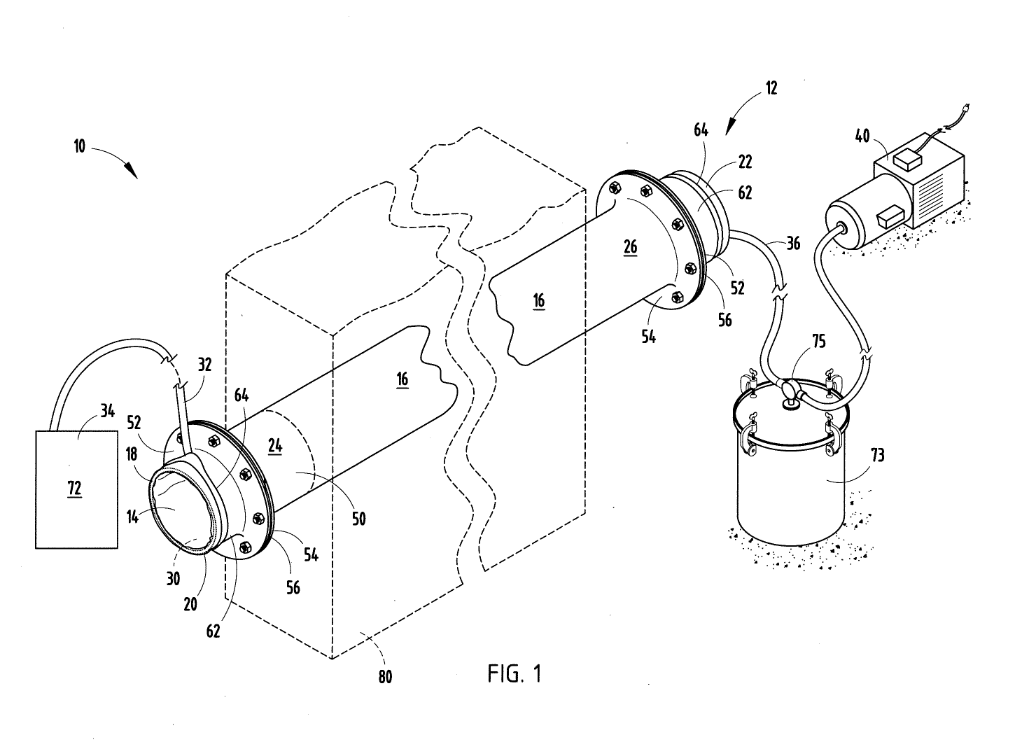

For purposes of description herein the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

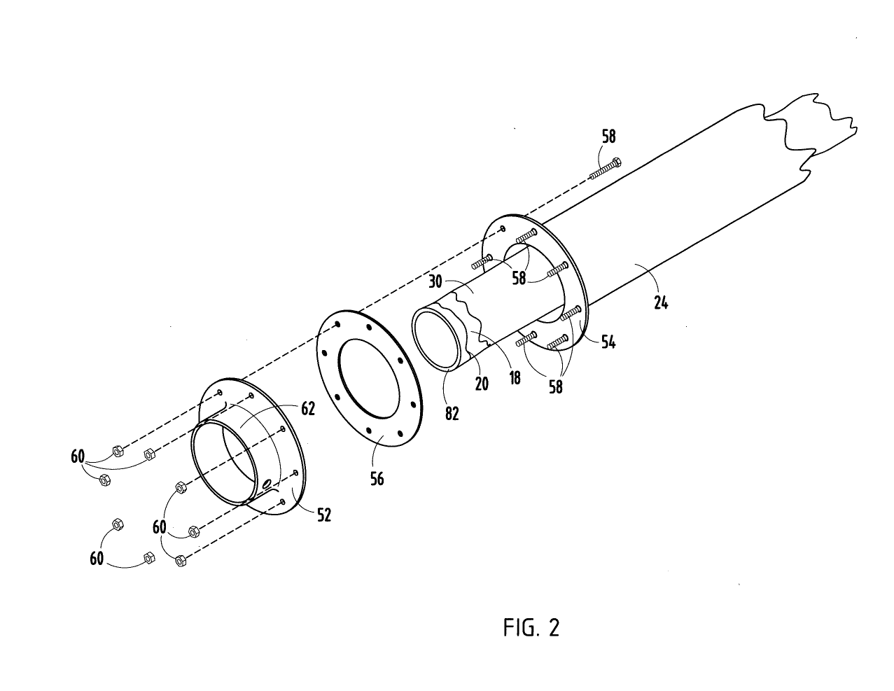

The reference numeral 10 shown in FIGS. 1 and 2 generally designates an infusion system embodying the present invention. The infusion system 10 includes a lining device 12 for lining an interior area 14 of a hollow object 16. A vacuum bag 18 includes first and second open ends 20, 22 removably sealed proximate first and second ends 24, 26 of the hollow object 16 to form a substantially tubular airtight cavity 28 between the hollow object 16 and the vacuum bag 18. A porous media 30 is positioned between the hollow object 16 and the vacuum bag 18. A draw hose 32 is in communication with the substantially airtight cavity 28. A liquid resin 34 is in communication with the draw hose 32. A vacuum hose 36 is connected with the vacuum bag 18 and in communication with the substantially airtight cavity 28. A vacuum source 40 is in communication with the vacuum hose 36, wherein activation of the vacuum source 40 results in a negative pressure in the vacuum hose 36, airtight cavity 28, and draw hose 32, thereby drawing resin 34 into the airtight cavity 28.

The porous media 30 (FIG. 1) and the infusion tube or vacuum bag 18 are made of a plastic material, and are lined in the pipe 16 with the porous media 30 sandwiched between the interior circumference of the pipe 16 and the vacuum bag 18. Both sides of the infusion tube 18 are taped to an external circumference 50 of the pipe 16. The infusion tube 18 can be either an elastic infusion tube or inelastic infusion tube. The elastic tube is generally preferred because it will uniformly stretch to the inside diameter of the pipe 16, thus providing uniform appearance without any wrinkles as sometimes occurs with inelastic infusion tubes. However, the appropriate infusion tube will be determined based on the application and the object to be lined. The infusion system 10 is designed to line the interior circumferential area 14 of the hollow object or pipe 16, either polymeric or steel, thereby extending the life of the pipe 16.

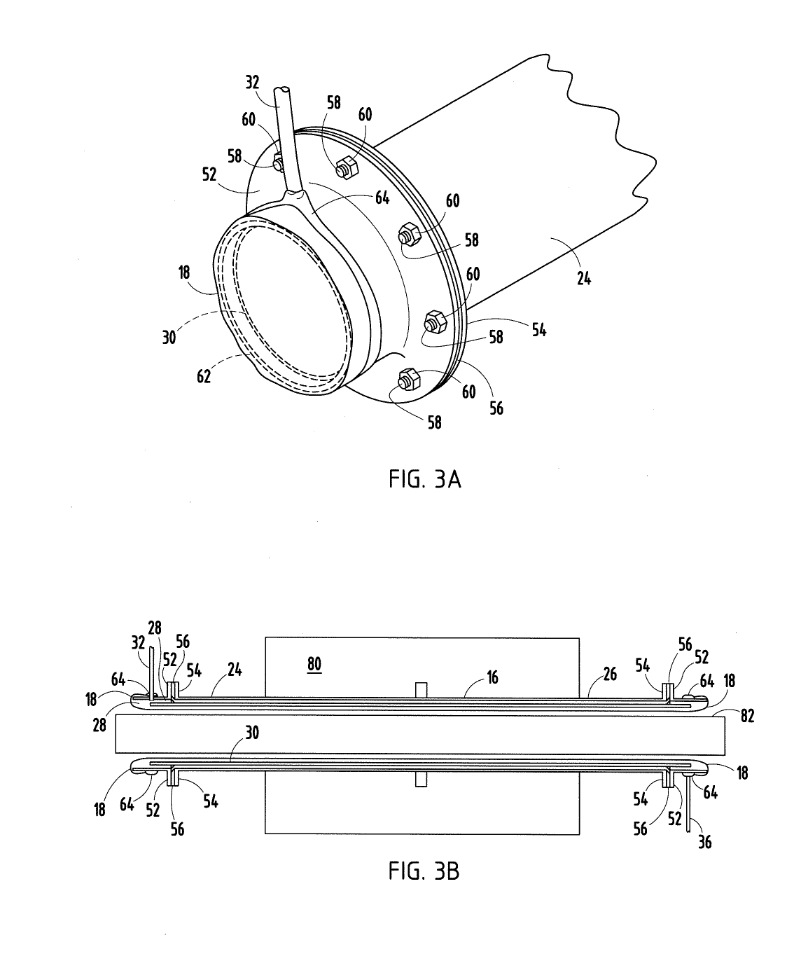

Referring to FIG. 2, prior to lining the pipe 16, a removable flange end 52 is connected with a flange end 54 on each of the first and second ends 24, 26 of the pipe 16. For illustrational purposes, only the first end 24 will be discussed below. A fiber-reinforced plastic ring 56 is installed between the removable flange end 52 and the flange end 54 on the first end 24 of the pipe 16. Mechanical fasteners 58 are engaged with mechanical receivers 60 to secure the removable flange end 52 to the flange end 54 on the pipe 16 sandwiching the fiber-reinforced plastic ring 56 therebetween. The vacuum bag 18 is installed in the pipe 16 and wraps around an outer circumference 62 of the removable flange end 52 (FIG. 3A). The first end 20 of the vacuum bag 18 is secured to the outer circumference 62 of the removable flange end 52 by an airtight sealing material 64, which prohibits air from leaving or entering the substantially airtight cavity 28 (FIG. 3B) formed between the vacuum bag 18 and the pipe 16. The vacuum hose 36 is secured to the removable flange end 52 on the first end 24 of the pipe 16 and the draw hose 32 is connected to the removable flange end 52 on the second end 26 of the pipe 16, as shown in FIG. 1.

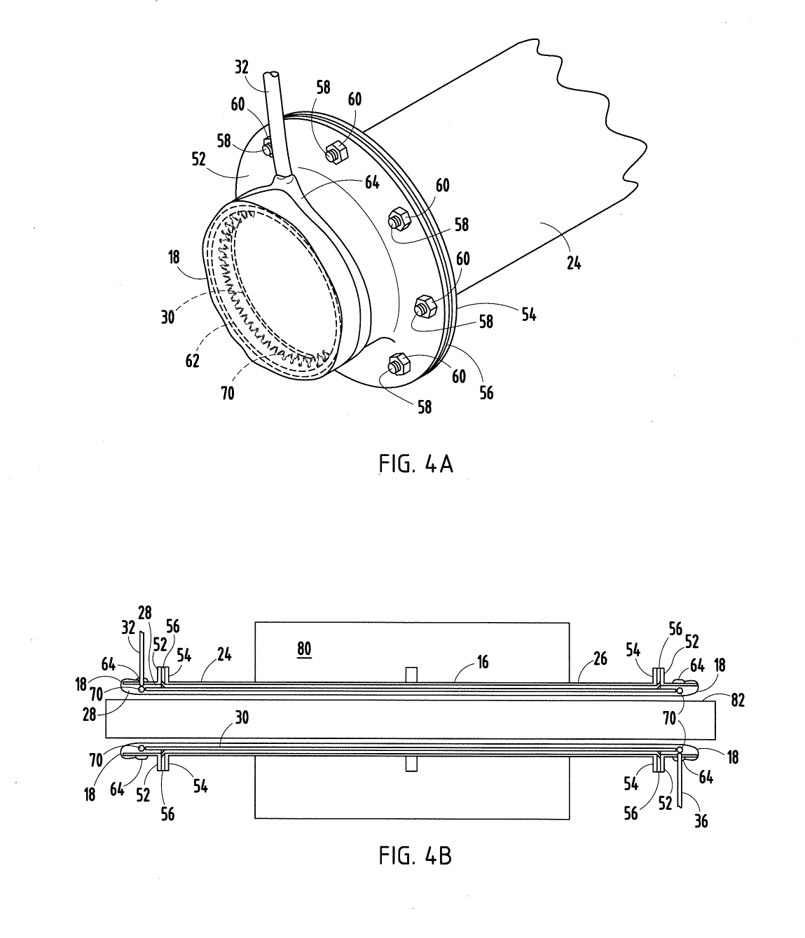

As shown in the embodiment illustrated in FIGS. 4A and 4B, an open spiral tube 70 may be installed between the vacuum bag 18 and the pipe 16 in the substantially airtight cavity 28. The open spiral tube 70 provides a circumferential void in which resin 34 can be drawn from the draw hose 32. The open spiral tube 70 increases the rate of flow of resin 34 from the draw hose 32 into the substantially airtight cavity 28, thus lessening the period of time it takes to line the interior circumference of the pipe 16. It is contemplated that another open spiral tube 70 could also be installed on the other end of the pipe 16 that is connected with the vacuum hose 36.

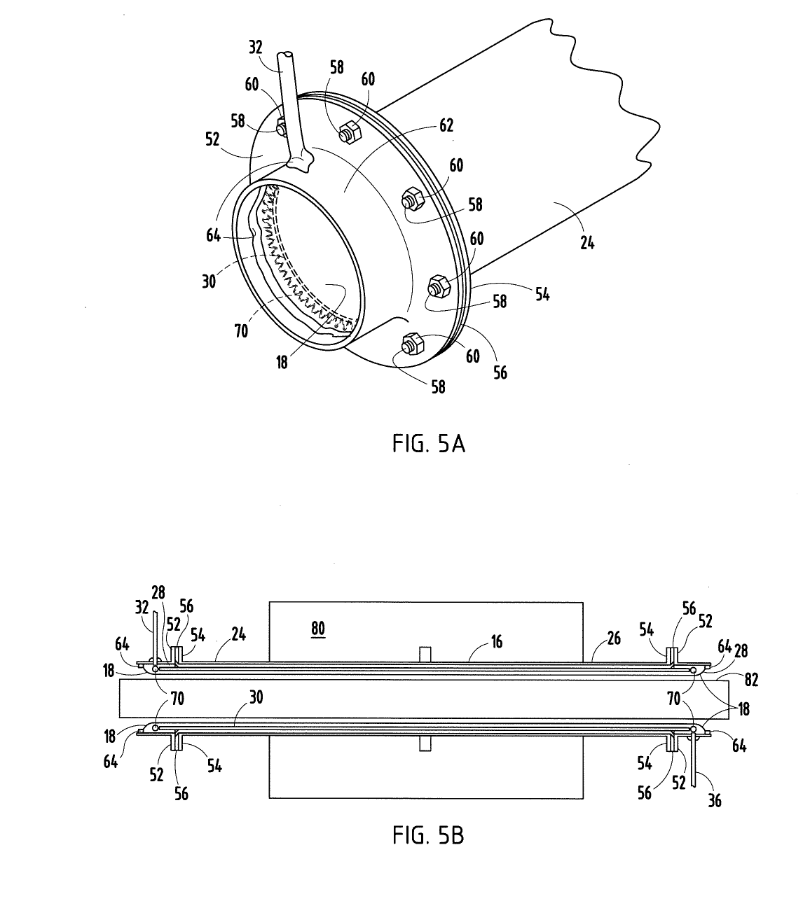

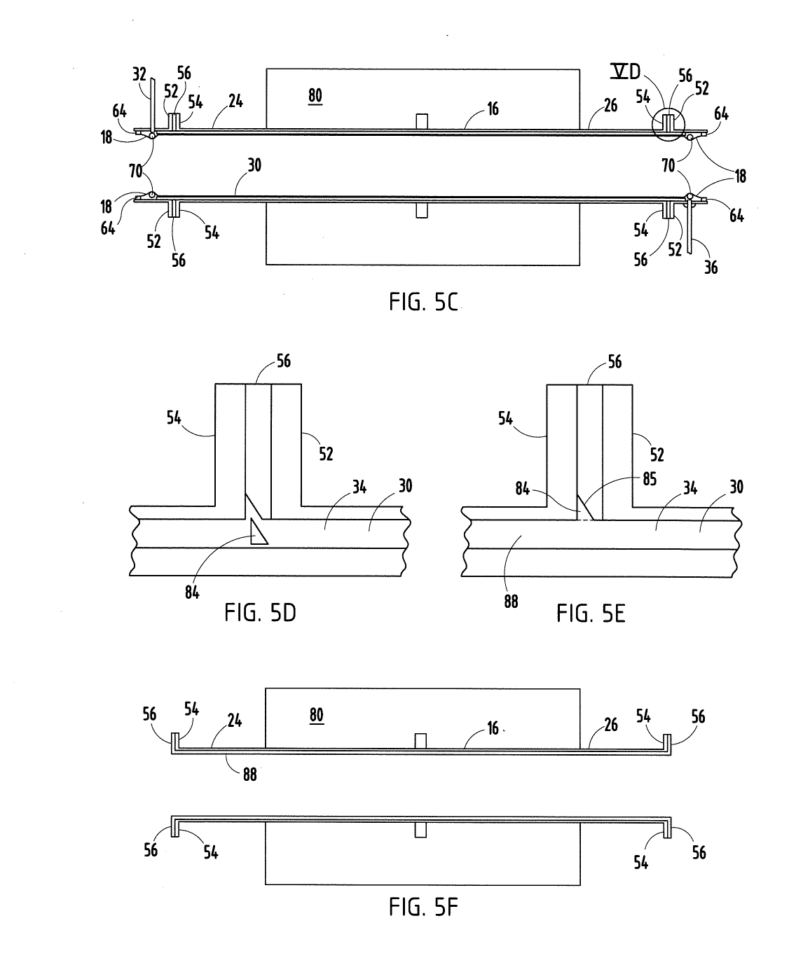

As shown in the embodiment illustrated in FIGS. 5A and 5B, the first end 20 of the vacuum bag 18 may be secured to an inner circumference of the removable flange end 52 by the airtight sealing material 64. Accordingly, air cannot leave or enter the substantially airtight cavity 28 formed between the vacuum bag 18 and the pipe 16. In this instance, the vacuum hose 36 is secured to the outer circumference adjacent an opening in the removable flange end 52 proximate to the open spiral tube 70.

Referring now to FIGS. 5C-5E, pipes 16 that are secured in an existing concrete wall 80, often need to be lined to increase the life of the pipe 16. To install the system 10, the infusion tube or vacuum bag 18, which is supported by a material carrier 82 (FIG. 2), is inserted into the pipe 16. The removable flange end 52 is placed adjacent to the existing flange end 54 on the pipe 16 and the fiber-reinforced plastic ring 56 is placed therebetween. As previously mentioned, the removable flange end 52 is positioned on both the first end 24 and on the second end 26.

Referring again to FIGS. 5C-5E, to begin the infusion process, the draw hose 32 is inserted into a resin container 72 (FIG. 1) and then the vacuum system 40 is activated. The vacuum system 40 draws air through the vacuum hose 36 from the space occupied by the porous media 30 between the vacuum bag 18 and the pipe 16, which consequently crushes the porous media 30 and also consequently draws resin 34 from the resin container 72 through the draw hose 32. To assist in the vacuum procedure, the open spiral tube 70 (FIG. 5A) may be used, which is adjacent to the inside diameter of the pipe 16. The open spiral tube 70 includes multiple openings or gaps, which increases the draw of resin 34 from the draw hose 32 into the pipe 16. As shown in FIG. 5D, a chamfer 84 may be provided around an outer circumference 50 of the pipe 16 adjacent the fiber-reinforced plastic ring 56. The chamfer 84 allows for resin 34 to flow slightly up into the fiber-reinforced plastic ring 56 area between the removable flange end 52 and the existing flange end 54, thereby increasing a surface area connection 85 between the fiber-reinforced plastic ring 56 and a hardened resin coating 88 (FIG. 5E). Over time, the resin 34 fills the porous media 30 sandwiched between the infusion tube 18 and the pipe 16. After the resin 34 hardens, the hardened resin coating 88 is bonded to the fiber-reinforced plastic ring 56. A collection container 73 with a pressure gauge 75 (FIG. 1) may be positioned along the vacuum hose 36 to monitor the pressure between the infusion tube 18 and the pipe 16. The collection container 73 also collects excess resin 34, thereby preventing damage to the vacuum system 40. This method allows for a uniform layer of resin 34 to be placed throughout the pipe 16, regardless of the length and diameter of the pipe 16.

Referring to FIG. 5F, after the resin 34 has been drawn into the pipe 16 and is evenly dispersed through the porous media 30, the vacuum hose 36 can be removed and the draw hose 32 can be pulled out. The removable flange end 52 is then removed from the fiber-reinforced plastic ring 56 and the fiber-reinforced plastic ring 56 is removed from the existing flange end 54 on both the first and second ends 24, 26 of the pipe 16. As a result, the finished pipe 16, the cross-section of which is shown in FIG. 5E, is provided with the hardened resin coating 88. The hardened resin coating 88 is corrosion and wear-resistant, thus increasing the longevity of the pipe 16. If the hardened resin coating 88 is not thick enough, or if several layers of hardened resin coating 88 are desired, than the process can be repeated. It is contemplated that the infusion process disclosed above can be completed in a similar manner for the embodiments disclosed in FIGS. 3A and 3B, as well as FIGS. 4A and 4B.

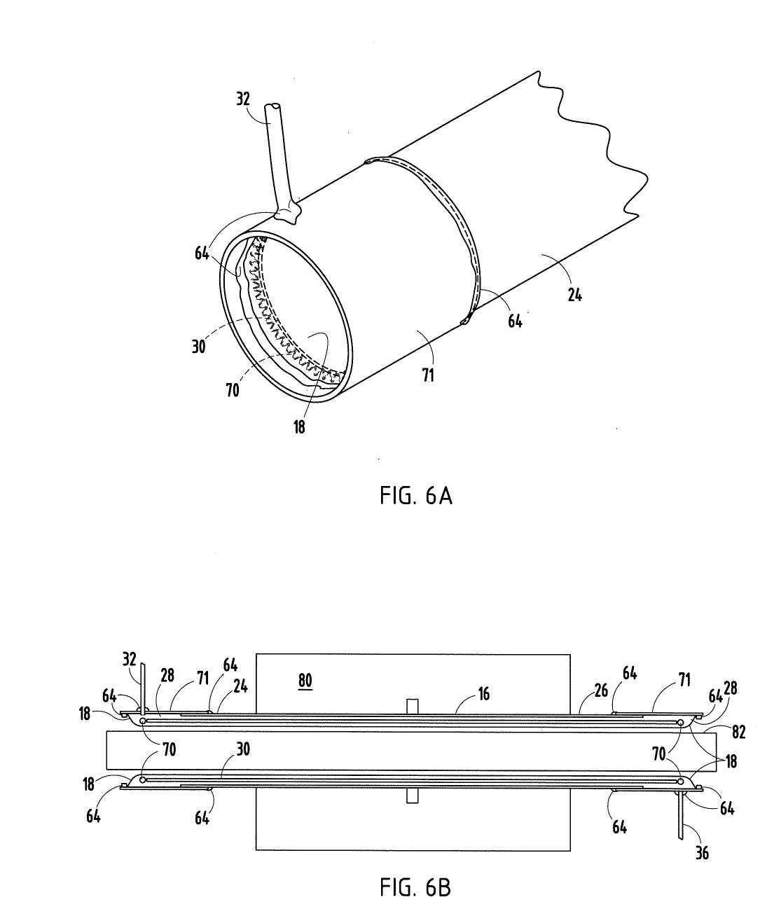

Referring now to the embodiment illustrated in FIGS. 6A and 6B, when the existing pipe 16 to be lined does not include existing flange ends 52, 54, a removable sleeve 71 having an inside diameter slightly larger than an outside diameter of the pipe 16 is slid over the ends of the pipe 16. The sleeve 71 operates similar to the removable flange end 52, and is made airtight with the pipe 16 by the addition of airtight sealing material 64 that is applied to an outside diameter of the pipe 16 adjacent to an end of the sleeve 71. The infusion process is then carried out in a similar manner to that detailed above with respect to FIGS. 5A-5E.

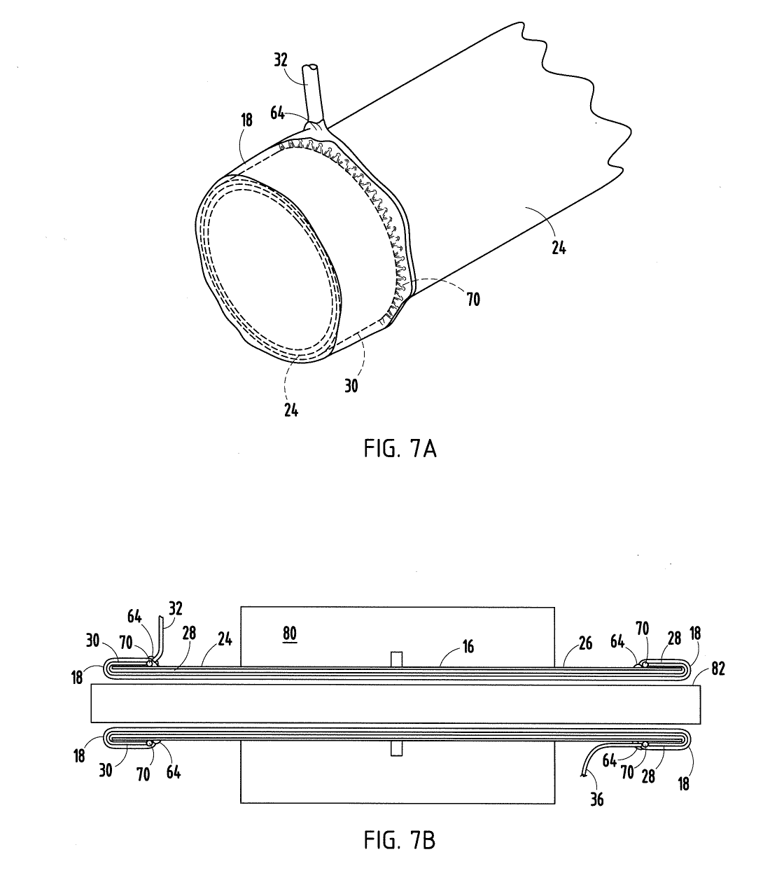

Referring now to the embodiment illustrated in FIGS. 7A and 7B, the vacuum bag 18 is pulled over the pipe 16 and wrapped over the ends of the pipe 16 when the pipe 16 does not include existing flange ends 52, 54 and when use of the sleeve 71 is undesirable. The open spiral tube 70 extends around the outer circumference of the pipe 16 and the draw hose 32 is positioned adjacent to the open spiral tube 70. After the resin 34 has been drawn into the pipe 16 and has set, the vacuum bag 18 may be removed and any additional hardened resin coating 88 that extends outside the pipe 16 will be left. The infusion process is then carried out in a similar manner to that detailed above with respect to FIGS. 5A-5E.

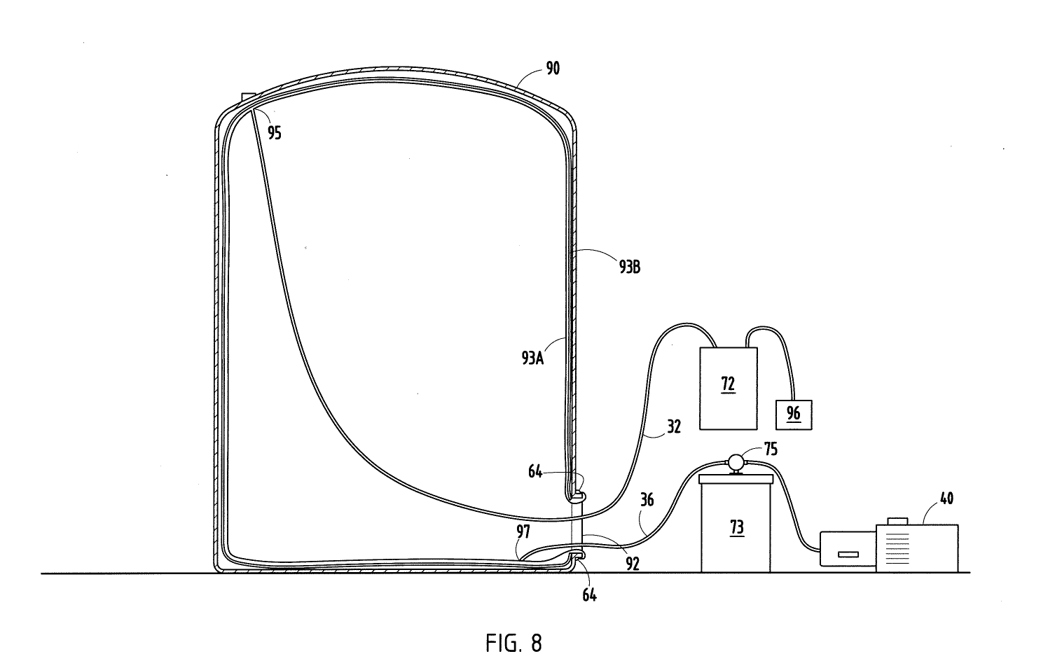

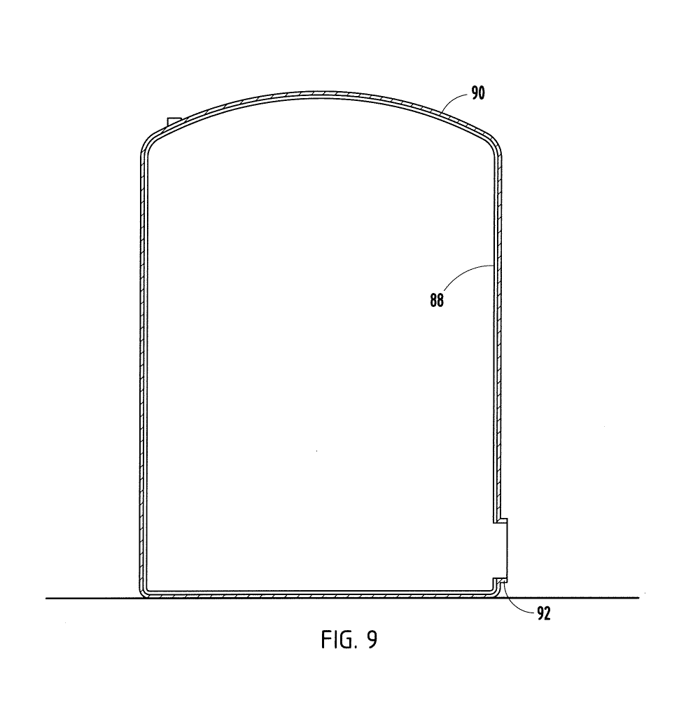

Referring to FIGS. 8 and 9, the illustrated embodiment shows another application for the lining device 10. The lining device 10 is being used to line a large storage tank 90. The storage tank 90 is lined in a similar manner as the pipe 16 discussed above. The tank 90 includes an opening 92 in which a large liner 93A and porous media 93B are inserted. The open spiral tube 70 may be positioned near the opening 92 to assist with resin 34 flow. A first end of the draw hose 32 is connected to a resin inlet 95 on the tank 90 and a second end of the raw hose 32 is connected to the resin container 72. A first end of the vacuum hose 36 is connected to a vacuum outlet 97 on the tank 90 and a second end of the hose 36 is connected to the vacuum system 40. The resin inlet 95 is generally positioned on a portion of the tank 90 that is opposite that of the vacuum outlet 97, as shown in FIG. 8. The collection container 73 may be connected with the vacuum hose 36 and positioned between the outlet 97 and the vacuum system 40. The porous media 93B is saturated with resin 34 as the vacuum hose 36 draws air from the tank 90 via the vacuum system 40. After resin 34 has completely lined the inside of the tank 90, the resin 34 is allowed to cure into the hardened resin coating 88 and the lining device 10 and liner 93A can be removed (FIG. 9). A pump assist 96 may be provided that applies positive pressure to the resin 34 in the resin container 72. The positive pressure assists pushing resin 34 into the draw hose 32 and consequently into the tank 90.

The above description is considered that of the preferred embodiments only. Modifications of the invention will occur to those skilled in the art and to those who make or use the invention. Therefore, it is understood that the embodiments shown in the drawings and described above is merely for illustrative purposes and not intended to limit the scope of the invention, which is defined by the following claims as interpreted according to the principles of patent law, including the Doctrine of Equivalents.

The invention claimed is:

1. A method for lining an interior portion of a pipe, the method comprising:
inserting a vacuum bag having a first end and a second end inside the pipe;
inserting a porous media between the vacuum bag and the pipe;
removably sealing the first end of the vacuum bag to a first end of the pipe;
removably sealing the second end of the vacuum bag to a second end of the pipe;
forming an airtight cavity between the vacuum bag and the pipe;
removably connecting a draw hose from the airtight cavity to a resin container;
removably connecting a vacuum hose from the airtight cavity to a vacuum source;
activating the vacuum source thereby drawing resin from the resin container into the draw hose and the airtight cavity; and
setting the liquid resin until the liquid resin has formed a hardened layer.

2. The method of claim 1, further comprising:
removing the vacuum bag.

3. The method of claim 1, further comprising:
installing an open spiral tube between the vacuum bag and the pipe.

4. The method of claim 1, wherein the step of inserting a vacuum bag further includes providing a vacuum bag made of a substantially elastic material.

5. The method of claim 1, further comprising:
extending the pipe length with one of a removable flange end or a removable sleeve.

6. The method of claim 1, further comprising:
forming a chamfer around the outer circumference of the pipe.

7. The method of claim 1, wherein the step of inserting a porous media between the vacuum bag and the pipe further comprises:
inserting a porous media having a three-dimensional layer that allows resin to flow therethrough.

8. A method for lining the interior of a container, the method comprising:
inserting a porous media against an interior wall of the large container;
inserting a flexible vacuum bag having an open mouth against the porous media;
removably sealing the open mouth of the vacuum bag to the large container adjacent an opening in the container;
forming an airtight cavity between the vacuum bag and the container;
removably connecting a first end of a draw hose to the vacuum bag such that the draw hose is in communication with the airtight cavity;
connecting a second end of the draw hose to a resin container;
removably connecting a first end of a vacuum hose to the vacuum bag such that the vacuum hose is in communication with the airtight cavity;
connecting a second end of the vacuum hose to a vacuum source;
activating the vacuum source thereby drawing air from the airtight cavity and creating a low pressure condition;
drawing resin from the resin container into the draw hose and the airtight cavity; and
setting the liquid resin until the liquid resin has formed a hardened layer.

9. The method of claim 8, further comprising:
removing the vacuum bag.

10. The method of claim 8, further comprising:
installing an open spiral tube adjacent the opening in the container.

11. The method of claim 8, wherein the step of inserting a vacuum bag further includes providing a vacuum bag made of a substantially elastic material.

12. A lining device for lining an interior area of a cylindrical hollow object, comprising:
a vacuum bag having first and second open ends removably sealed proximate first and second ends of said hollow object to form a substantially tubular airtight cavity between the hollow object and the vacuum bag;
a porous media positioned between the hollow object and the vacuum bag;
a draw hose in communication with the substantially airtight cavity;
a liquid resin in communication with the draw hose;
a vacuum hose connected with the vacuum bag and in communication with the substantially airtight cavity; and
a vacuum source in communication with the vacuum hose, wherein activation of the vacuum source results in a negative pressure in the vacuum hose, airtight cavity, and draw hose, thereby drawing resin from the reservoir into the airtight cavity.

13. The lining device of claim 12, wherein the vacuum bag includes an elastic infusion tube having an unstretched diameter less than an inner diameter of the hollow object.

14. The lining device of claim 12, further comprising:
an open spiral tube disposed near one end of the vacuum bag.

15. The lining device of claim 12, wherein the hollow object is a hollow pipe.

16. The lining device of claim 12, further comprising:
a flange ring disposed on at least one of the first and second ends.

17. The lining device of claim 12, wherein the hollow object includes a removable flange end disposed on at least one end of the hollow object.

18. The lining device of claim 12, further comprising:
the hollow object includes a removable sleeve disposed on at least one end of the hollow object.

19. The lining device of claim 12, wherein the vacuum bag is sealed to an outer circumference of the hollow object.

20. The lining device of claim 12, wherein the vacuum bag is sealed to an inner circumference of the hollow object.
